(19) United States
(12) Patent Application Publication
(10) Pub. No.: US 2002/0076602 A1
(43) Pub. Date: Jun. 20, 2002

(54) Direct liquid fuel cell and a novel binary electrode therefor

(75) Inventors: Gennadi Finkelshtain, Givat Ada (IL); Gershon Borovsky, Gush Etzion (IL); Boris Filanovsky, Armon HaNatziv Jerusalem (IL); Yuri Katzman, Hadera (IL)

Correspondence Address: Dr Mark Friedman LTD, c/o Bill Polkinghorn - Discovery Dispatch, 9003 Florin Way, Upper Marlboro, MD, 20772, US

(73) Assignee: MORE ENERGY LTD.

(21) Appl. No.: 09/737,951

(22) Filed: Dec. 18, 2000

(51) Int. Cl. H01M 4/86; H01M 8/08; H01M 4/90; H01M 12/06; H01M 8/22

(52) U.S. Cl. 429/40; 429/46; 429/27; 429/13

(57) ABSTRACT

A fuel cell comprising: (a) a binary anode, (b) a cathode, and (c) a liquid electrolyte disposed between and interacting with the binary anode and the cathode, wherein the binary anode includes at least one liquid fuel and at least one solid fuel. Preferably, the electrolyte includes an alcohol such as methanol, and the solid fuel includes aluminum, magnesium and/or zinc.

### FIELD AND BACKGROUND OF THE INVENTION

The present invention relates to a binary electrode for a direct methanol fuel cell and a portable fuel cell based on such a binary electrode.

Fuel cells based on oxygen reduction and hydrogen oxidation are well known for at least 100 years [V. Plzak, B. Rohland, and H. Wendt, “Fuel Cell Systems and Their Technical Maturity” Modern Aspects of Electrochemistry (Ed. B. Conway and J. O. M. Bokris), Vol. 26, pp. 147-161, 1990; G. Iwasita-Vielstich, “Progress in the Study of Methanol Oxidation”, Advances in Electrochemical Science and Engineering (Ed. H. Gerischer and C. W. Tolias), pp. 127-170, 1990]. Modern H₂/O₂ systems are well developed and can provide high power parameters.

Nevertheless, the hazardous components along with the bulky and heavy equipment required for this type of fuel cell have led to the use of various other types of fuel, and more specifically, to the use of aqueous solutions of organic alcohols and to the use of some primary nitrogen based liquids [M. McNicol. J. Electroanal. Chem. Vol. 118, p. 71, 1981; M. Watanabe. Electrochim. Acta, Vol. 20, p. 267, 1975; D. Pletcher and V. Solis, Electrochim. Acta, Vol. 27, p. 775, 1982].

On the base of the above-mentioned systems, it is possible to engineer miniaturized direct methanol fuel cells (DMFCs). The vast majority of DMFCs are based on polymer exchanged membranes (PEM) as an electrolyte. Unfortunately, low power densities, short life times as well as problems related to carbon monoxide (CO) poisoning seriously restrict their utility and application.

Most publications regarding DMFCs relate to the process of methanol oxidation on Pt and binary Pt—Me catalysts [A. B. Trepkovich and N. Marinkovich, Sov. Elektrochimiya, Vol. 31, p. 1075, 1995; V. Bagotsky and Y. Vasiliev. Electrochim. Acta, Vol. 16, p. 2141, 1971; M. McNicol, J. Electroanal. Chem., Vol. 118, p. 71, 1981; M. Watanabe, Electrochim. Acta, Vol. 20, p. 267, 1975; D. Pletcher and V. Solis, Electrochim. Acta, Vol. 27, p. 775, 1982; J. Clavillier and C. Lamy, J. Electroanal. Chem., Vol. 125, p. 249, 1981; R. Adzic and A. B. Trepkovich, Nature, Vol. 296, p. 137, 1982]. This reaction was studied in various electrolytes both on platinum (Pt) poly-crystals and mono-crystals.

The oxidation of methanol on Pt catalysts is a multi-stage reaction, which can be presented, in somewhat simplified form, as follows:

CH₃OH+Pt₍ₛ₎→Pt—CH₂OH+H⁺+e⁻ (1)

Pt—CH₂OH+Pt₍ₛ₎→Pt₂—CHOH+H⁺+e⁻ (2)

Pt₂—CHOH+Pt₍ₛ₎→Pt₃—COH+H⁺+e⁻ (3)

Pt₃—COH→Pt₃—CO+2Pt₍ₛ₎+H⁺+e⁻ (4)

Pt₍ₛ₎+H₂O→Pt—OH+H⁺+e⁻ (5)

PtOH+Pt—CO→Pt—COOH (6a)

or

Pt—CO+H₂O→Pt−COOH+H⁺+e⁻ (6b)

Pt—COOH→Pt₍ₛ₎+CO₂H⁺+e⁻ (7)

Additional suggested reactions include:

Pt—CH₂OH→Pt₍ₛ₎+HCHO+e⁻ (8)

Pt₂CHOH+Pt—OH→3Pt₍ₛ₎+HCOOH+H⁺+e⁻ (9)

or

Pt₂CHOH+H₂O→2Pt₍ₛ₎+HCOOH+2H⁺+e⁻ (10)

Pt₃C—OH+Pt—OH→3Pt₍ₛ₎+Pt—COOH+H⁺e⁻ (11)

or

Pt₃C—OH+H₂O→2Pt₍ₛ₎+Pt—COOH+2H⁺+2e⁻ (12)

The sum total of the above reactions may be represented by:

CH₃OH+H₂O→CO₂+6H⁺+6e⁻ (A)

A schematic representation of the process is provided in FIG. 1.

The rate of each ‘electrochemical’ stage depends on the value of the current exchange rate and can be expressed as:

k₀=I₀/nFSₑₗc₀ (II)

wherein:

n=number of electrons;

I₀=exchange current;

F=Faraday constant;

Sₑₗ=electrochemically active surface area of the electrode;

c₀=volume concentration of methanol.

It is well known that the limiting stage of the process is reaction (4), because the reaction rate is at least 3-4 magnitudes of order below the rate of any other reaction. It is therefore obvious that the rate of the reaction (A) decreases with time.

It is generally accepted that DMFCs having liquid electrolyte are impractical [J. O. M. Bokris and S. Srinivasan, Fuel Cells, Elsevier (1969)]. Known cathodes are attacked by methanol, hence, cells are designed such that the methanol comes in contact only with the anode, where the oxidation of the methanol (and consumption of water) to carbon dioxide is effected. Thus, in order to inhibit the attack on the cathode, solid PEMs are used to bridge between cathode and anode, instead of having liquid electrolyte between the electrodes.

It must be emphasized that the use of polymer exchanged membranes in DMFCs has not been particularly successful. One major problem that has yet to be overcome is the rapid and irreversible deactivation of the anode. It is generally accepted that the major process contributing to anode poisoning is the formation of CO as an intermediate product in the oxidation of methanol to carbon dioxide and following formation of an adsorbed particles like CO_{ads}/Pt, as shown in the series of reactions herein above.

Another major problem specific to PEM-based direct methanol fuel cells is that methanol attacks the membrane. To prevent rapid destruction of the membrane, extremely dilute methanol solutions (<3% by weight) must be provided to the fuel cell. However, the use of such dilute solutions seriously compromises cell efficiency.

Moreover, the methanol must be pumped to the surface of the anode. Consequently, in addition to the above-mentioned deficiencies, such DMFCs are inappropriate for miniature applications, such as portable power sources for appliances, communication devices (e.g., cellular phones), laptop computers, and PDAs.

Finally, it is noted that although water is consumed at the anode in the methanol oxidation reaction,

CH₃OH+H₂O→CO₂+6H⁺+6e⁻ (A)

water is produced at the cathode in the reduction of oxygen:

O₂+4H⁺+4e⁻→2H₂O (B)

Upon balancing equations (A) and (B), we obtain:

CH₃OH+3/2O₂→CO₂+2H₂O (C)

from which it is evident that water is a net product of the fuel cell. Thus, a recirculating methanol solution becomes increasingly dilute as the reaction proceeds, such that the efficiency of the cell is even further decreased. Consequently, an additional, cumbersome processing step is required to remove the excess water from the system.

There is therefore a recognized need for, and it would be highly advantageous to have, a DMFC that overcomes the deficiencies inherent in existing DMFCs, providing both high power parameters and excellent long-term performance. It would be of particular advantage to have such a DMFC in miniature, portable form, such that the DMFC could be implemented in various specialized applications such as cellular phones and PDAs.

### SUMMARY OF THE INVENTION

The present invention relates to a binary electrode for a direct methanol fuel cell (DMFC) and a fuel cell that utilizes such a binary electrode.

One main object of the present invention is to provide a binary anode, in which the characteristic decreasing current density of a fuel cell which ‘blockage’ of the electrode active surface is made temporary and reversible, such that the current output of the anode (and a corresponding fuel cell), over time, is largely unaffected.

It has been discovered by the inventors that certain binary electrodes promote the oxidation of both liquid fuels (aqueous organic liquids) and solid fuels (containing Al and/or Mg and/or Zn or other combination of the three).

It has been further discovered by the inventors that the introduction of such solid fuels can appreciably increase the overall current density of a fuel cell.

Thus, according to the teachings of the present invention there is provided a fuel cell, including: (a) a binary anode; (b) a cathode, and (c) a liquid electrolyte disposed between and interacting with the binary anode and the cathode, wherein the binary anode includes at least one liquid fuel and at least one solid fuel.

According to yet another aspect of the present invention there is provided a binary anode for a direct liquid fuel cell, the binary anode including: (a) a platinum-containing catalytic layer; (b) a solid fuel containing a metal selected from the group consisting of aluminum metal, magnesium metal, zinc metal, aluminum-magnesium alloy, zinc-magnesium alloy, aluminum-zinc alloy, and aluminum-magnesium-zinc alloy, and (c) a liquid fuel.

According to yet another aspect of the present invention there is provided a method of producing current in a direct liquid fuel cell, including the steps of: (a) providing a fuel cell including: (i) a binary anode; (ii) a cathode, and (iii) a liquid electrolyte disposed between and interacting with the binary anode and the cathode, wherein the binary anode includes at least one liquid fuel and at least one solid fuel; (b) oxidizing the liquid fuel at the anode, and (c) oxidizing the solid fuel at the anode.

According to further features in the described preferred embodiments, the electrolyte includes an alcohol.

According to still further features in the described preferred embodiments, the alcohol is between about 10% and about 45% of the electrolyte by weight.

According to still further features in the described preferred embodiments, the alcohol is methanol.

According to still further features in the described preferred embodiments, the cathode includes a plurality of catalytically active transition metal particles.

According to still further features in the described preferred embodiments, the at least one solid fuel includes aluminum.

According to still further features in the described preferred embodiments, the aluminum includes aluminum powder.

According to still further features in the described preferred embodiments, the aluminum includes aluminum metal particles.

According to still further features in the described preferred embodiments, the at least one solid fuel includes magnesium.

According to still further features in the described preferred embodiments, the at least one solid fuel includes zinc.

According to still further features in the described preferred embodiments, the at least one solid fuel includes an alloy selected from the group consisting of aluminum-magnesium alloys, zinc-magnesium alloy, aluminum-zinc alloy, and aluminum-magnesium-zinc alloy.

According to still further features in the described preferred embodiments, the at least one liquid fuel includes hydrazine.

According to still further features in the described preferred embodiments, the cathode includes: (i) an electrically conducting sheet, and (ii) a catalytic polymer film, bonded to a side of the sheet that faces the electrolyte, the catalytic polymer film including a highly electroconducting polymer having at least one heteroatom per backbone monomer unit thereof and a plurality of transition metal atoms covalently bonded to at least a portion of the heteroatoms.

According to further features in the described preferred embodiments, the fuel cell further includes: (d) an insulating fuel cell frame, the frame having a compartment for housing the binary anode, the cathode, and the liquid electrolyte.

According to still further features in the described preferred embodiments, the fuel cell further includes: (e) a replaceable fuel cartridge, the cartridge disposed within the frame, the cartridge containing the solid fuel.

According to further features in the described preferred embodiments, the cartridge further contains the liquid fuel.

According to still further features in the described preferred embodiments, the cartridge is disposed outside of the compartment.

According to still further features in the described preferred embodiments, the cartridge is disposed within the compartment.

According to still further features in the described preferred embodiments, the cartridge further contains the liquid electrolyte.

According to still further features in the described preferred embodiments, H+ and electrons are generated at the anode, the method further including: (d) reacting oxygen at the cathode with the H+ and the electrons to produce water.

According to still further features in the described preferred embodiments, the oxidizing of the liquid fuel results in partial deactivation of a catalytically-active surface of the anode, and wherein the wherein the oxidizing of the solid fuel results in a reactivation of the catalytically-active surface.

According to still further features in the described preferred embodiments, the partial deactivation is caused by carbon monoxide.

According to still further features in the described preferred embodiments, the fuel cell provides a substantially cyclic supply of current.

According to still further features in the described preferred embodiments, the method of the present invention further includes: (d) introducing at least the solid fuel into the fuel cell using a replaceable cartridge.

According to still further features in the described preferred embodiments, the liquid fuel is introduced using the cartridge.

The present invention successfully addresses the shortcomings of the existing technologies by providing a system for and method of operating a direct methanol fuel cell having a liquid electrolyte. The present invention is simple, reliable and inexpensive, and provides a powerful, portable energy source having excellent cyclability.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1a is a schematic cut-apart view of a fuel cell according to the present invention;

FIG. 1b provides a side view of the fuel cell provided in FIG. 1a;

FIG. 2a illustrates a binary electrode according to the present invention, which includes a solid fuel (metal electrode 38) as a layer alongside a standard Pt-based anode 40 for methanol oxidation;

FIG. 2b illustrates a binary electrode according to the present invention, which includes a solid fuel—metal powder 42—disposed within the catalytic layer of Pt-based anode 40;

FIG. 3 provides a schematic representation of the operation of a direct liquid methanol fuel cell according to the present invention;

FIG. 4 provides a schematic representation of a liquid fuel cell having a fuel cartridge, according to the present invention;

FIG. 5 is a characteristic graph illustrating the current-time dependence for a fuel cell of the present invention;

FIG. 6 is a graph providing a characteristic voltammetric curve (potential vs. current) for a fuel cell of the present invention.

### DESCRIPTION OF THE PREFERRED EMBODIMENTS

The present invention relates to a binary electrode for a direct methanol fuel cell (DMFC) and a fuel cell that utilizes such a binary electrode.

It has been discovered by the inventors that certain binary electrodes promote the oxidation of both liquid fuels, such as aqueous organic liquids, and solid fuels (containing Al and/or Mg and/or Zn or other combination of the three). Moreover, while fuel cells having solely liquid fuel are generally characterized by a decreasing current density resulting from deactivation of the electrode active surface by carbon monoxide and the like, the integration of a solid fuel with the liquid fuel causes such deactivation to be temporary and reversible, such that the current output of the anode (and a corresponding fuel cell), over time, is largely unaffected.

It has been further discovered by the inventors that the introduction of such solid fuels can appreciably increase the overall current density of a fuel cell.

The principles and operation of the fuel cell and the binary electrode thereof, according to the present invention, may be better understood with reference to the drawings and the accompanying description.

Before explaining at least one embodiment of the invention in detail, it is to be understood that the invention is not limited in its application to the details of construction and the arrangement of the components set forth in the following description or illustrated in the drawing. The invention is capable of other embodiments or of being practiced or carried out in various ways. Also, it is to be understood that the phraseology and terminology employed herein is for the purpose of description and should not be regarded as limiting.

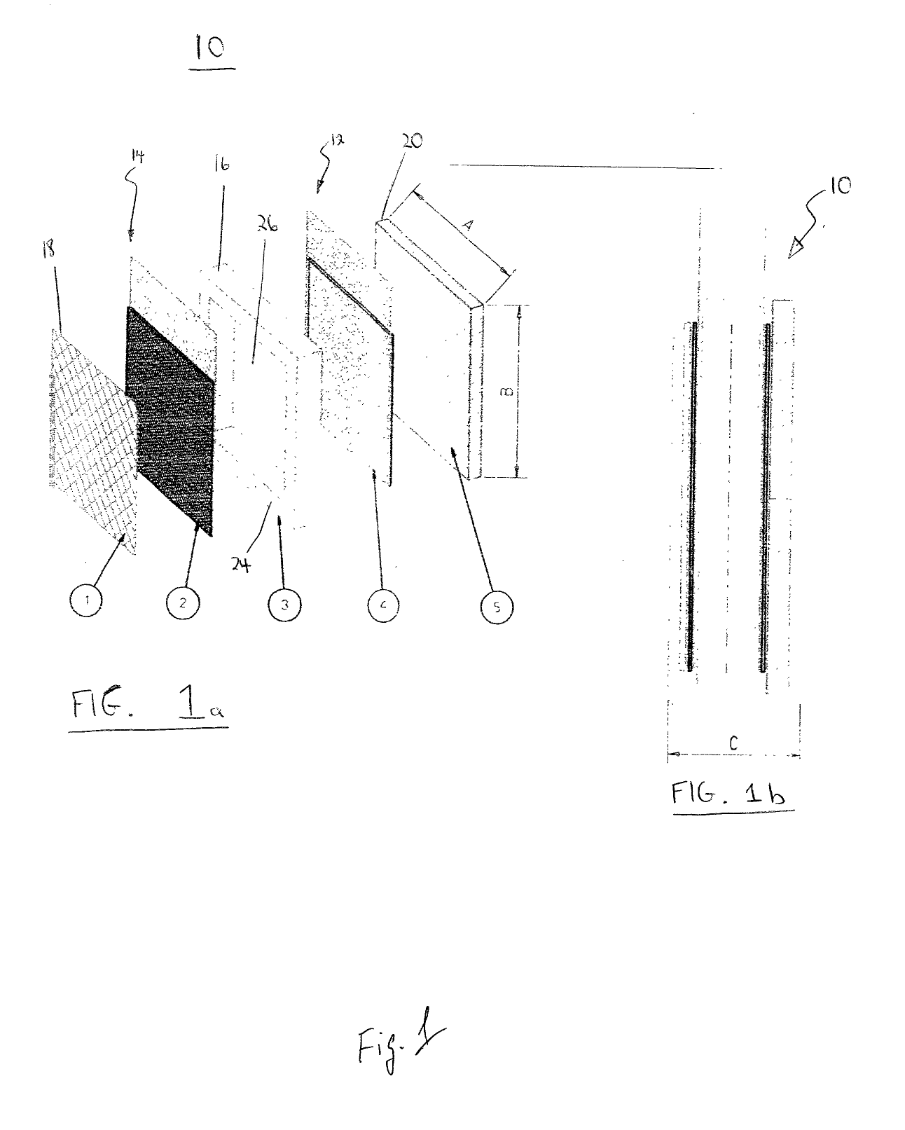

Referring now to the drawings, FIG. 1a is a schematic cut-apart view of a fuel cell 10 according to the present invention. The fuel cell is made up of an anode 12 and a cathode 14, a cell body 16, a protective mesh 18 covering for the cathode 14, and a protective cover 20 in back of the anode 12. Components 12, 14, 18, and 20 are substantially rectangular layers having a length A and width B. The cell body 16 has a rectangular frame 24 of length A and width B, and a hollow interior 26 for containing the liquid electrolyte (not shown). The fuel cell components 12, 14, 16, 18, and 20 are layered in a congruent fashion, such that the length of the cell is substantially A, the width of the cell is substantially B, and the combined thickness of fuel cell components 12, 14, 16, 18, and 20 is C, wherein C is preferably small in relation to both A and B. A side view of the fuel cell 10 is provided in FIG. 1b.

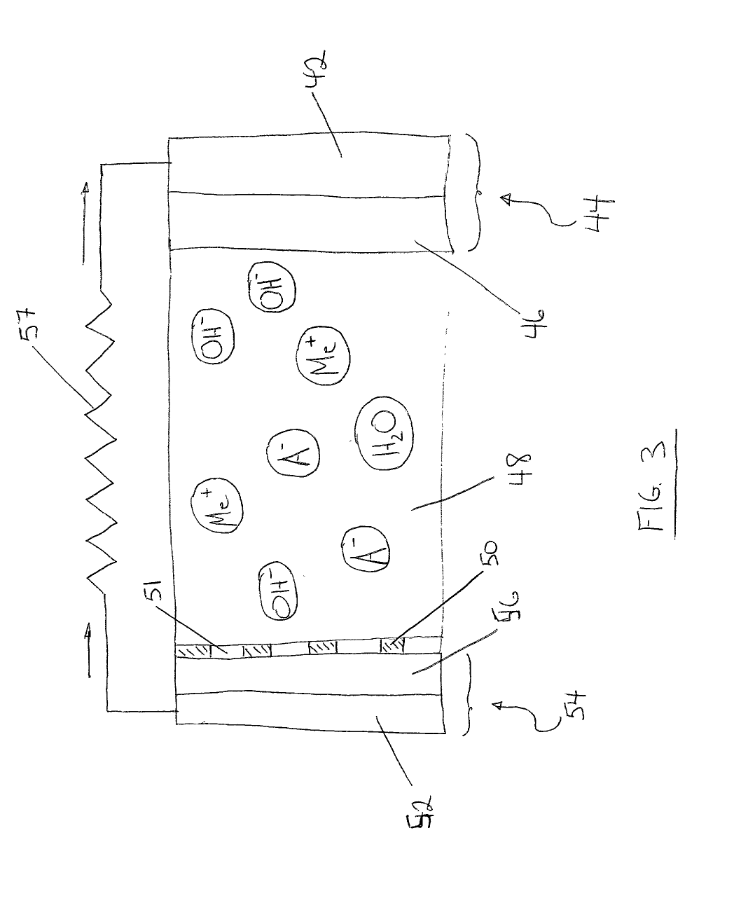

The anode 12 is a binary anode containing a conventional anode material and a solid fuel. Various configurations of the binary anode are possible, two of which are described in greater detail in FIG. 3 below.

Looking now at FIG. 1a, the cathode 14 is covered by a protective mesh covering 18 that also serves as a support. More importantly, the structure of protective mesh covering 18 is designed to allow the permeation of air through protective mesh covering 18 and on to the surface of cathode 14. The air contains oxygen, a stoichiometric reactant in the fuel cell reaction. Protective cover 20 in back of anode 12 provides support and protection to anode 12, and is non-permeable to air (the presence of which is detrimental to anode 12).

The heart of the fuel cell is made up of cathode 14, anode 12, and between them situated cell body 16 containing the liquid electrolyte (not shown).

Both anode 12 and cathode 14 are composed of at least two components: a support and a catalytically-active substance, usually in the form of distinct layers. These electrode layers are depicted in an offset fashion in FIG. 1a, but are better seen from the side view provided in FIG. 1b. These layers are described in greater detail below.

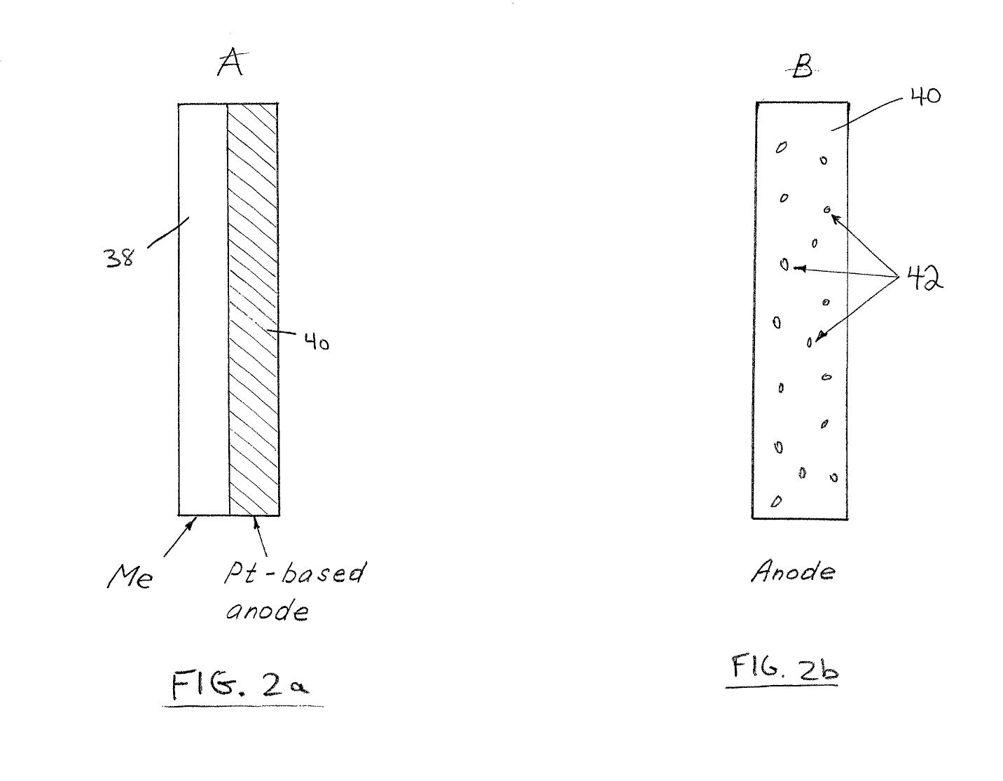

The integration of a solid fuel with the liquid fuel can be achieved in various ways. Preferably, and as shown in FIG. 2a, the integration achieved by adding a metal electrode 38 (i.e., the solid fuel) as a layer alongside a standard Pt-based anode 40 for methanol oxidation. Optionally and preferably, the binary electrode can be effected by disposing metal powder 42 directly into the catalytic layer of Pt-based anode 40, as illustrated in FIG. 2b.

The operation of a direct liquid methanol fuel cell according to the present invention is shown schematically in FIG. 3. The fuel cell 42 illustrated in FIG. 3 includes a cathode 44, an anode 54, and a liquid electrolyte 48. Cathode 44 has a catalytic layer 46 attached to carbon support 42. Anode 54 has a catalytic layer 56 attached to support 52. Support 52 includes a conductive material. Both solid fuel 50 and liquid fuel 51 are disposed between cathode 44 and anode 54, substantially adjacent to catalytic layer 56 of anode 54.

At anode 54, the methanol reacts with water to produce carbon dioxide, according to the following reaction:

CH₃OH+H₂O→CO₂+6H⁺+6e⁻

The H⁺ produced migrates in electrolytic solution 48 to the surface of cathode 44. The electrons produced are passed to cathode 44 via resistor 57.

At cathode 44, oxygen from the ambient air reacts with the H⁺ and the electrons from anode 54 to produce water, according to the following reaction:

3/2O₂+6H⁺+6e⁻→3H₂O

The overall reaction in the direct liquid methanol fuel cell of the present invention is obtained by combining the reactions at anode 54 and cathode 44:

CH₃OH+3/2O₂→CO₂+2H₂O

As the reaction in the fuel cell progresses, the concentration of water, which is a stoichiometric product of the overall fuel cell reaction, builds up within the electrolyte. As a result, the methanol concentration is reduced from a high initial concentration, typically 30-40% by weight, to a low spent fuel cell concentration of 4-6%. It must be emphasized that even the final, spent fuel cell concentration compares favorably with the operating methanol concentration of 3% that is characteristic of DMFCs of the prior art.

The integration of a solid fuel with the liquid fuel (methanol) significantly boosts the potential energy within the fuel cell, such that the theoretical cell longevity is greatly extended. Moreover, the practical longevity is also greatly improved, as will be elaborated below, due to the reversible nature of the catalytic deactivation in the fuel cell of the present invention. As further elaborated below, the present invention also allows for the repletion of the spent fuel without compromising the portability of the fuel cell.

A preferred cathode for the above-described fuel cell is described in a co-pending U.S. patent application (Ser. No. 09/503,592), which is incorporated by reference for all purposes as if fully set forth herein. However, a variety of cathodes may be used in the fuel cell of the present invention. Preferably, the cathode includes an electrically conducting sheet and a catalytic polymer film, bonded to a side of the sheet facing the electrolyte, wherein the catalytic polymer film includes a highly electroconducting polymer having at least one heteroatom per backbone monomer unit thereof and a plurality of transition metal atoms covalently bonded to at least a portion of the heteroatoms.

The anode is a binary anode having a carbon support, a platinum-containing catalytic layer, and a metal, solid-fuel electrode. Other precious metals may be used instead of, or in addition to, platinum.

In a preferred embodiment according to the present invention, the solid fuel includes aluminum, magnesium, and/or zinc, or alloys containing one or more of these elements.

The electrolyte used in the fuel cell of the present invention is a liquid electrolyte, preferably alkaline.

In a preferred embodiment according to the present invention, the liquid electrolyte includes a base/water solution and at least one aliphatic alcohol (e.g., methanol, ethanol).

In additional to the well-known problems of methanol attack and gradual deactivation of the catalytically active surface, known DMFCs require methanol recirculation and concentration, by the removal of water, to maintain the methanol concentration within fixed limits. Consequently, known DMFCs have cumbersome auxiliary equipment, and are decidedly non-portable.

Portable fuel cells must overcome an additional problem: fuel depletion. In the fuel cell having a binary electrode according to the present invention, the fuel density and longevity of the cell are greatly enhanced by the solid metal fuel incorporated into the electrode.

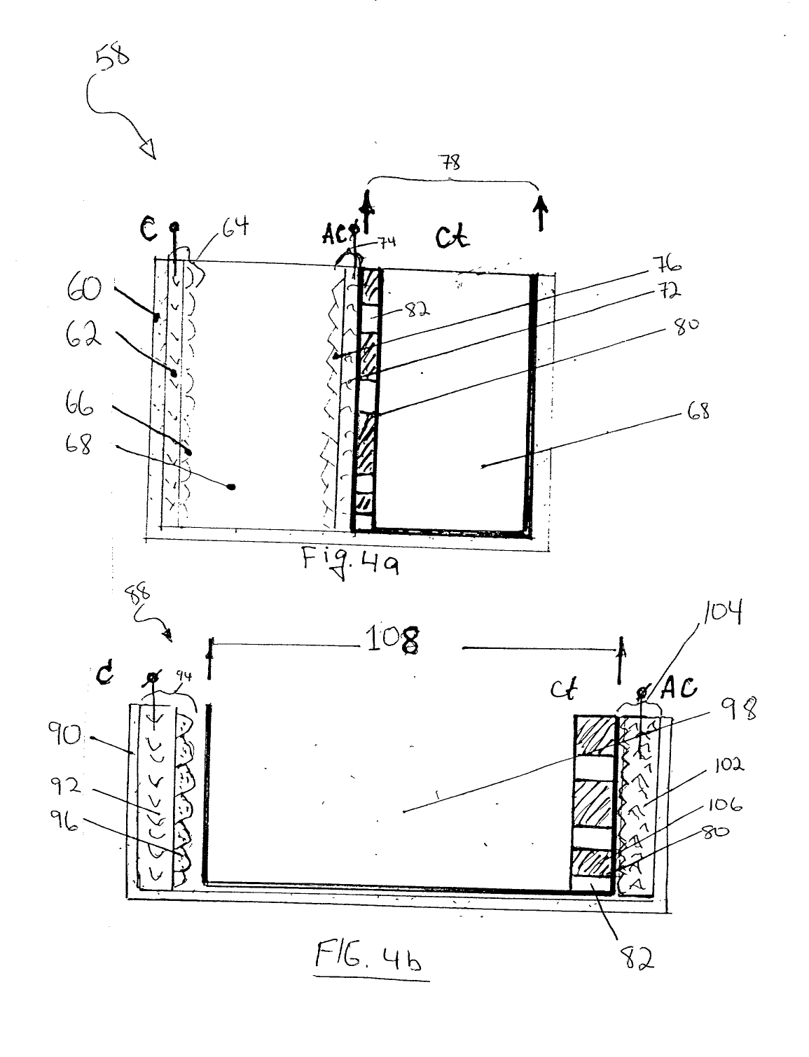

Moreover, in another aspect of the present invention, the liquid fuel cell is provided with a fuel cartridge 78 (FIGS. 4a, 4b). Preferably, fuel cartridge 78 is replaceable. The fuel cell 58 illustrated in FIG. 4a includes a cell frame 60, a carbon support 62 for the cathode 64, a catalytic layer 66 attached to carbon support 62, a liquid electrolyte 68, a carbon support 72 for anode 74, a catalytic layer 76 attached to carbon support 72 of anode 74, and a fuel cartridge 78. Within fuel cartridge 78 are disposed a solid fuel 80 and a liquid fuel 82. Fuel cartridge 78 is situated outside the liquid fuel cell, i.e., outside the anode 74—cathode 64 regime, and adjacent to carbon support 72 of anode 74, and within the confines of cell frame 60.

According to a preferred embodiment of the present invention, the fuel cartridge is disposed within the liquid fuel cell (FIG. 4b). The fuel cell 88 includes a cell frame 90, a carbon support 92 for the cathode 94, a catalytic layer 96 attached to carbon support 92, a liquid electrolyte 98, a carbon support 102 for anode 104, a catalytic layer 106 attached to carbon support 102 of anode 104, and a fuel cartridge 108. Within fuel cartridge 108 are disposed a solid fuel 80 and a liquid fuel 82. Fuel cartridge 108 is situated within the liquid fuel cell, between anode 104 and cathode 94, and adjacent to carbon support 102 of anode 104, and within the confines of cell frame 90. Thus, in this embodiment, liquid fuel 82 is contained within electrolyte 98.

The cartridges of FIGS. 4a and 4b allow for the facile replacement and repletion of both liquid fuel and solid fuel in the fuel cell.

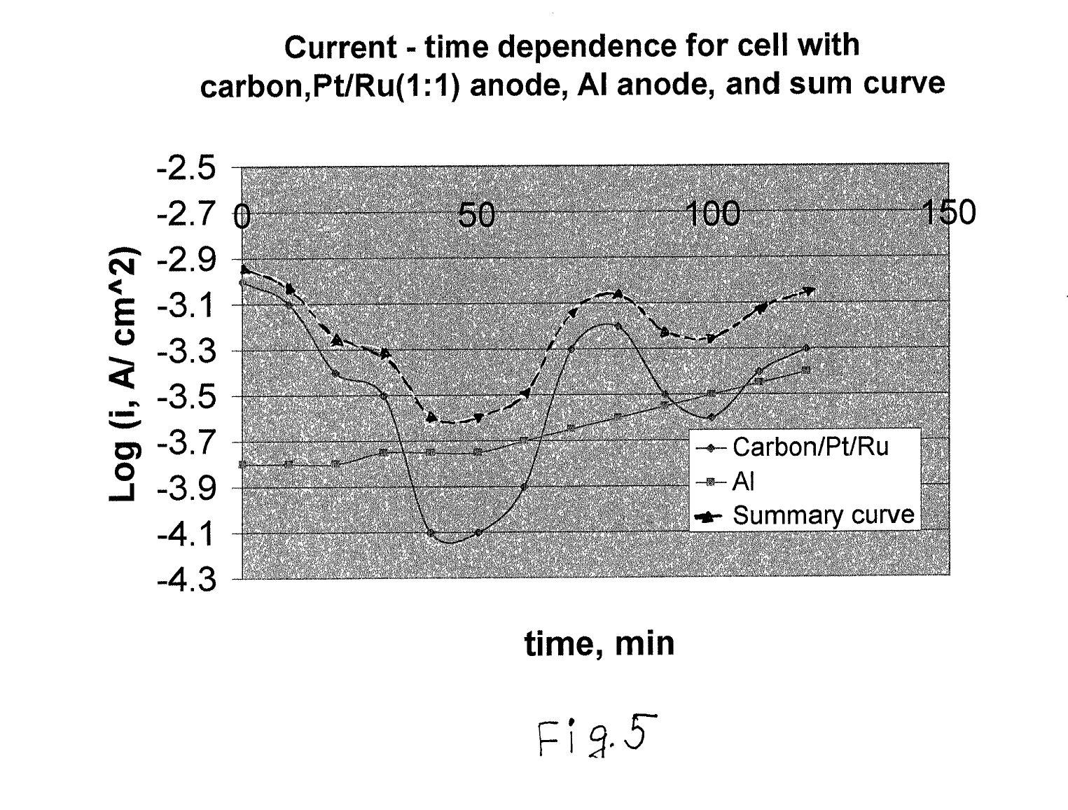

FIG. 5 provides a characteristic graph illustrating the current-time dependence for a fuel cell of the present invention.

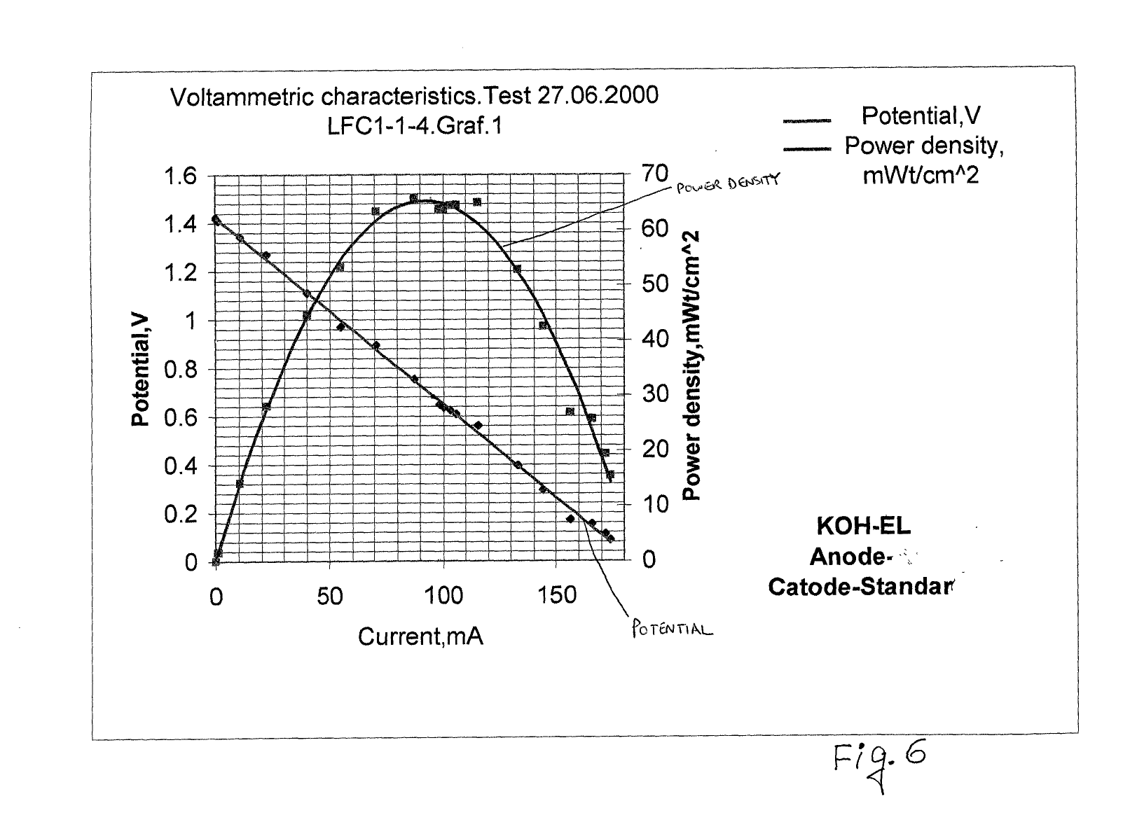

FIG. 6 is a graph providing a characteristic voltammetric curve (potential vs. current) for a fuel cell of the present invention.

As used herein in the specification and in the claims section that follows, the term “binary electrode”, “binary anode”, and the like refer to an anode which provides the appropriate surface for the reaction of both a liquid fuel and a solid fuel. A typical anode of this type contains a carbon support layer and a catalytically-active anode for methanol oxidation along with a metal (e.g. aluminum), solid fuel electrode.

### EXAMPLES

Reference is now made to the following examples, which together with the above descriptions, illustrate the invention in a non-limiting fashion.

### Example 1

The fuel cell includes the cathode disclosed in a pending patent of the inventors (U.S. patent application Ser. No. 09/503,592) i.e., a Pt/Ru (1:1) catalyst, placed on a nickel mesh anode, and combined with an aluminum powder as a solid fuel source. The construction of the cell corresponds to FIG. 4a.

During the initial stage of the fuel cell discharge, when the value of the current exchange rate for the oxidation of methanol is significantly larger than that of Al oxidation (I₀^{CH}^{₃}^{OH}>>I₀^{Al}), the actual current density of a cell is completely defined by the oxidation of methanol. As the formation of CO (Reaction 4) on the catalytically-active surface of the anode increases, the current exchange rate for the oxidation of methanol gradually decreases, until reaching the condition in which I₀^{CH}^{₃}^{OH}<<I₀^{Al}. At this point, the overall current density of the fuel cell is defined, approximately, by k₀^{Al}. During this part of the cycle, CO is gradually removed from the catalytically-active surface.

Without wishing to be limited by theory, it is believed that the CO is consumed as a result of the oxidation of the aluminum. The oxidation of the aluminum metal can be represented as follows:

Al₍ₛ₎−3e⁻=Al⁺³

The presence of CO on the catalytically-active surface doesn't appear to directly influence this reaction. However, as a result of the above-described oxidation, the CO reacts with an anionic species (designated as OH⁻) to produce HCO₃⁻, as follows:

CO+OH⁻=HCO₃⁻

The product of the reaction is reversibly desorbed from the catalytically-active surface.

The reduction in CO concentration catalytically-active surface results in the reattainment of the initial condition of I₀^{CH}^{₃}^{OH}>>I₀^{Al}. This process is repetitive, as is evident from FIG. 5. Voltammetric characteristics of the cell are provided in FIG. 6.

The theoretical capacity of the binary electrode equals 1.5 Ah/g. The experimental cell provided a measured capacity of 1.0 Ah/g.

### Example 2

The fuel cell includes the cathode disclosed in a pending patent of the inventors (U.S. patent application Ser. No. 09/503,592) i.e., a Pt/Ru (1:1) catalyst, placed on a nickel mesh anode, and combined with an aluminum powder as a solid fuel source. The construction of the cell corresponds to FIG. 4b.

The processes in the cell are substantially identical to those described in Example 1.

The theoretical capacity of the binary electrode is 1.5 Ah/g. The experimental cell provided a measured capacity of 0.9-0.95 Ah/g.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A fuel cell, comprising:
(a) a binary anode;
(b) a cathode, and
(c) a liquid electrolyte disposed between and interacting with said binary anode and said cathode,
wherein said binary anode includes at least one liquid fuel and at least one solid fuel.

2. The fuel cell of claim 1, wherein said electrolyte includes an alcohol.

3. The fuel cell of claim 2, wherein said alcohol is between about 10% and about 45% of said electrolyte by weight.

4. The fuel cell of claim 3, wherein said alcohol is methanol.

5. The fuel cell of claim 1, wherein said cathode includes a plurality of catalytically active transition metal particles.

6. The fuel cell of claim 4, wherein said at least one solid fuel includes aluminum.

7. The fuel cell of claim 6, wherein said aluminum includes aluminum powder.

8. The fuel cell of claim 6, wherein said aluminum includes aluminum metal particles.

9. The fuel cell of claim 4, wherein said at least one solid fuel includes magnesium.

10. The fuel cell of claim 4, wherein said at least one solid fuel includes zinc.

11. The fuel cell of claim 4, wherein said at least one solid fuel includes an alloy selected from the group consisting of aluminum-magnesium alloys, zinc-magnesium alloy, aluminum-zinc alloy, and aluminum-magnesium-zinc alloy.

12. The fuel cell of claim 4, wherein said at least one liquid fuel includes hydrazine.

13. The fuel cell of claim 6, wherein said at least one liquid fuel includes hydrazine.

14. The fuel cell of claim 11, wherein said at least one liquid fuel includes hydrazine.

15. The fuel cell of claim 4, wherein said cathode includes:
(i) an electrically conducting sheet, and
(ii) a catalytic polymer film, bonded to a side of said sheet that faces said electrolyte, said catalytic polymer film including a highly electroconducting polymer having at least one heteroatom per backbone monomer unit thereof and a plurality of transition metal atoms covalently bonded to at least a portion of said heteroatoms.

16. The fuel cell of claim 1, further comprising:
(d) an insulating fuel cell frame, said frame having a compartment for housing said binary anode, said cathode, and said liquid electrolyte.

17. The fuel cell of claim 16, further comprising:
(e) a replaceable fuel cartridge, said cartridge disposed within said frame, said cartridge containing said solid fuel.

18. The fuel cell of claim 17, wherein said cartridge further contains said liquid fuel.

19. The fuel cell of claim 18, wherein said cartridge is disposed outside of said compartment.

20. The fuel cell of claim 18, wherein said cartridge is disposed within said compartment.

21. The fuel cell of claim 20, wherein said cartridge further contains said liquid electrolyte.

22. A binary anode for a direct liquid fuel cell, the binary anode comprising:
(a) a platinum-containing catalytic layer;
(b) a solid fuel containing a metal selected from the group consisting of aluminum metal, magnesium metal, zinc metal, aluminum-magnesium alloy, zinc-magnesium alloy, aluminum-zinc alloy, and aluminum-magnesium-zinc alloy, and
(c) a liquid fuel.

23. The binary anode of claim 22, wherein said liquid fuel includes hydrazine.

24. The binary anode of claim 22, wherein said liquid fuel includes methanol.

25. A method of producing current in a direct liquid fuel cell, comprising the steps of:
(a) providing a fuel cell including:
(i) a binary anode;
(ii) a cathode, and
(iii) a liquid electrolyte disposed between and interacting with said binary anode and said cathode,
wherein said binary anode includes at least one liquid fuel and at least one solid fuel;
(b) oxidizing said liquid fuel at said anode, and
(c) oxidizing said solid fuel at said anode.

26. The method of claim 25, wherein H+ and electrons are generated at said anode, the method further comprising:
(d) reacting oxygen at said cathode with said H+ and said electrons to produce water.

27. The method of claim 25, wherein said oxidizing of said liquid fuel results in partial deactivation of a catalytically-active surface of said anode, and wherein said wherein said oxidizing of said solid fuel results in a reactivation of said catalytically-active surface.

28. The method of claim 25, wherein said partial deactivation is caused by carbon monoxide.

29. The method of claim 25, wherein said fuel cell provides a substantially cyclic supply of current.

30. The method of claim 25, further comprising:
(d) introducing at least said solid fuel into the fuel cell using a replaceable cartridge.

31. The method of claim 30, wherein said liquid fuel is introduced using said cartridge.
